(19) United States
(12) Patent Application Publication
(10) Pub. No.: US 2024/0184843 A1
(43) Pub. Date: Jun. 6, 2024

(54) COMPUTER-READABLE RECORDING MEDIUM STORING OUTPUT PROGRAM, OUTPUT METHOD, AND INFORMATION PROCESSING APPARATUS

(71) Applicant: Fujitsu Limited, Kawasaki-shi (JP)

(72) Inventors: Yasunari HIKIMA, Kawasaki (JP); Ken KOBAYASHI, Setagaya (JP)

(73) Assignee: Fujitsu Limited, Kawasaki-shi (JP)

(21) Appl. No.: 18/241,238

(22) Filed: Sep. 1, 2023

(30) Foreign Application Priority Data
Oct. 25, 2022 (JP) 2022-170808

(51) Int. Cl. G06F 17/11

(52) U.S. Cl. CPC G06F 17/11

(57) ABSTRACT

A non-transitory computer-readable recording medium storing an output program for causing a computer to execute a process, the process includes acquiring first graph data related to solutions over a Pareto front and second graph data related to a plurality of evaluation values corresponding to the solutions, fitting a Bezier simplex to each of the acquired first graph data and the acquired second graph data, generating a plurality of data points that corresponds to each other over a Bezier simplex fitted to each of the first graph data and the second graph data, receiving input of a condition that indicates a range of each of the plurality of evaluation values, and outputting solutions indicated by data points over a Bezier simplex fitted to the first graph data, the data points corresponding to data points over a Bezier simplex fitted to the second graph data selected based on the received condition.

### CROSS-REFERENCE TO RELATED APPLICATION

This application is based upon and claims the benefit of priority of the prior Japanese Patent Application No. 2022-170808, filed on Oct. 25, 2022, the entire contents of which are incorporated herein by reference.

### FIELD

The embodiment discussed herein is related to a computer-readable recording medium storing an output program, an output method, and an information processing apparatus.

### BACKGROUND

Heretofore, in the field of designing an aircraft, an engine, or the like, there has been a case where a design value is selected based on solutions (design candidates) obtained by solving a multi-objective optimization problem. A multi-objective optimization problem is a problem in which a plurality of objective functions is simultaneously optimized, and there is a plurality of optimal solutions that gives an appropriate trade-off relationship between the objective functions. For this reason, in a case where a design value is selected from solutions obtained by solving a multi-objective optimization problem, it is a goal to obtain an optimal trade-off curved surface (Pareto front) obtained when a plurality of solutions is plotted in a multidimensional space.

As described above, as related art for obtaining a Pareto front from a plurality of solutions obtained by solving a multi-objective optimization problem, one in which a Bezier simplex model is fitted to a plurality of solutions plotted in a multidimensional space is known.

Bezier Simplex Fitting: Describing Pareto Fronts of Simplicial Problems with Small Samples in Multi-Objective Optimization, Internet <URL: https://www.aaai.org/ojs/index.php/AAAI/article/view/4069> is disclosed as related art.

### SUMMARY

According to an aspect of the embodiments, a non-transitory computer-readable recording medium storing an output program for causing a computer to execute a process, the process includes acquiring first graph data related to solutions over a Pareto front and second graph data related to a plurality of evaluation values corresponding to the solutions, fitting a Bezier simplex to each of the acquired first graph data and the acquired second graph data, generating a plurality of data points that corresponds to each other over a Bezier simplex fitted to each of the first graph data and the second graph data, receiving input of a condition that indicates a range of each of the plurality of evaluation values, and outputting solutions indicated by data points over a Bezier simplex fitted to the first graph data, the data points corresponding to data points over a Bezier simplex fitted to the second graph data selected based on the received condition.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for describing selection of a design candidate (solution) from a result of multi-objective optimization;

FIG. 2 is an explanatory diagram for describing a problem in a case where a Pareto front is not visualized;

FIG. 3 is an explanatory diagram for describing a case where a Pareto front is visualized;

FIG. 4 is a block diagram illustrating an example of the functional configuration of an information processing apparatus according to an embodiment;

FIG. 5 is an explanatory diagram for describing an example of input information;

FIG. 6 is an explanatory diagram for describing that a Pareto front is simplicial;

FIG. 7 is an explanatory diagram for describing an example of a Bezier simplex;

FIG. 8 is an explanatory diagram for describing fitting of a Bezier simplex to a Pareto front;

FIG. 9 is an explanatory diagram for describing an example of visualization of a Pareto front by fitting;

FIG. 10 is an explanatory diagram for describing an example of data points over a Bezier simplex;

FIG. 11 is an explanatory diagram for describing an example of condition specification by a user;

FIG. 12 is an explanatory diagram for describing an example of presentation of solutions in response to condition specification;

FIG. 13 is an explanatory diagram for describing an example of condition specification by a user and presentation of solutions;

FIG. 14 is a flowchart illustrating an example of the operation of the information processing apparatus according to the embodiment; and

FIG. 15 is an explanatory diagram for describing an example of the configuration of a computer.

### DESCRIPTION OF EMBODIMENTS

By fitting a Bezier simplex model according to the related art, it is possible to present Pareto solutions corresponding to points (evaluation values) over a Pareto front. However, there is a problem that a user has to specify all the evaluation values of points over a Pareto front in order to present solutions, and it is not easy to select a solution desired by the user.

Hereinafter, the embodiments of techniques capable to support selection of the solution will be described below with reference to the drawings. In the embodiment, configurations having the same function are denoted by the same reference sign, and redundant description thereof is omitted. The output program, output method, and information processing apparatus to be described in the embodiment below are merely examples, and do not limit the embodiment. Portions of the embodiment below may be appropriately combined as long as the portions do not contradict each other.

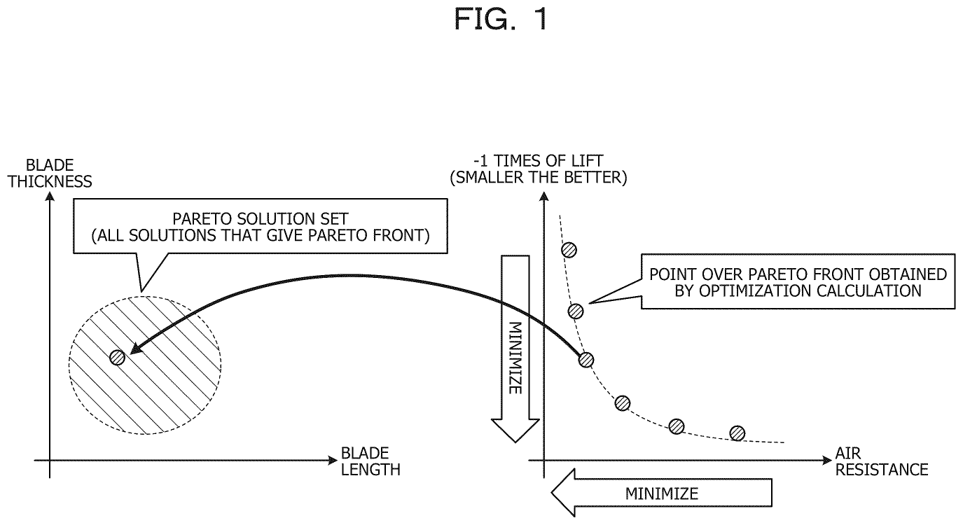

FIG. 1 is an explanatory diagram for describing selection of a design candidate (solution) from a result of multi-objective optimization. As illustrated in FIG. 1, in the field of design, a user selects a desired solution from points over a Pareto front (dotted line in the drawing) obtained by solving a multi-objective optimization problem, and selects the solution as a design value. The illustrated example exemplifies selection of a design value in designing an airplane, and a user selects two evaluation values of (−1 times of lift) and (air resistance) illustrated on the right side in FIG. 1 from points over a Pareto front obtained by optimization calculation. Accordingly, the user may select a specific design candidate (solution) from the Pareto solution set (all solutions that give the Pareto front) for (blade thickness) and (blade length) illustrated on the left side in FIG. 1.

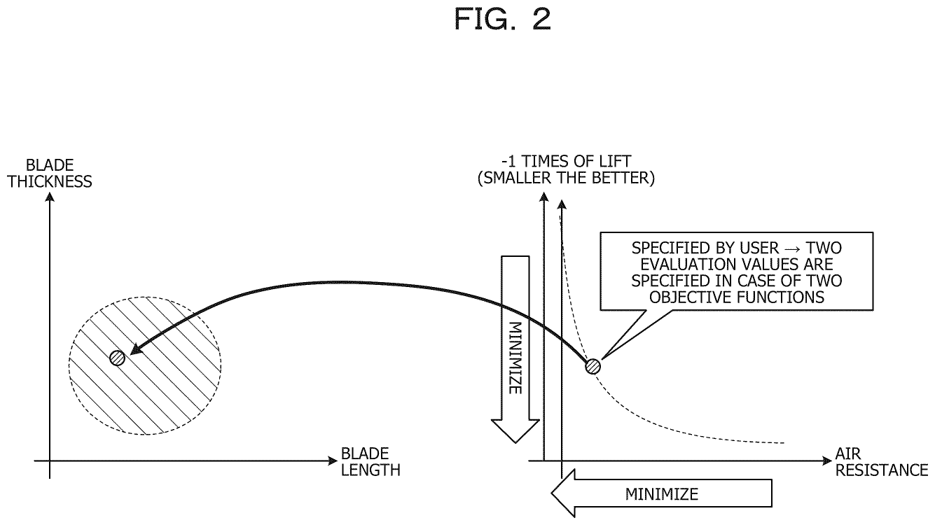

FIG. 2 is an explanatory diagram for describing a problem in a case where a Pareto front is not visualized. As illustrated in FIG. 2, in order to present solutions, a user has to specify all the evaluation values of points over a Pareto front. For example, in a case where there are two objective functions, in a method considered in related art, a user specifies points over a Pareto front of evaluation values visualized by screen display, thereby specifying two evaluation values corresponding to the specified points. For example, an objective function is the evaluation value described above. In a case where the number of objective functions is large (for example, four or more), a Pareto front may not be visualized in a manner capable of visual determination by a user, and data points may not be directly specified. For example, in a case where the number of objective functions is three, even when a Pareto front may be visualized by three-dimensional display, there is a possibility that the work of a user to directly specify points over the Pareto front displayed on a screen is complicated. From the above, it is difficult for a user to directly specify all the evaluation values over a Pareto front, especially in a case where the number of objective functions is three or more.

The information processing apparatus according to the embodiment constructs a Bezier simplex representing graph data of solutions over a Pareto front and evaluation values corresponding to the solutions. For example, the information processing apparatus according to the embodiment fits a Bezier simplex to graph data of solutions over a Pareto front and evaluation values corresponding to the solutions. A Bezier simplex means a Bezier curve defined by using a plurality of control points and generalized to a high dimension.

By constructing a Bezier simplex representing graph data in this manner, the information processing apparatus according to the embodiment may present Pareto solutions corresponding to specified points over a Pareto front.

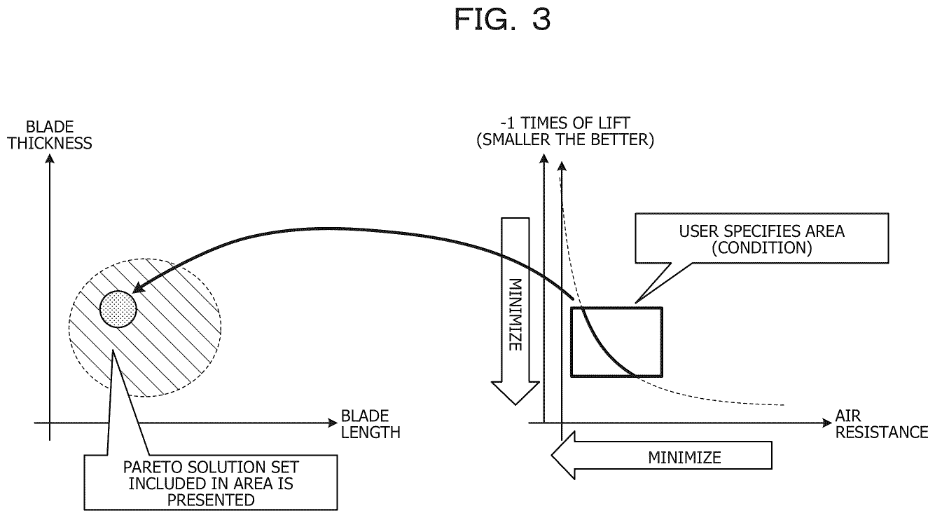

FIG. 3 is an explanatory diagram for describing a case where a Pareto front is visualized. In the example illustrated in FIG. 3, Bezier simplex fitting has been applied to the graph data of Pareto solution set (left side in FIG. 3) and the graph data of Pareto front of evaluation values (right side in FIG. 3). Accordingly, as illustrated in FIG. 3, the information processing apparatus according to the embodiment may specify a condition for evaluation values and present solutions corresponding to the evaluation values included in the area that satisfies the condition (in a case where there is no evaluation value included in the area, a solution corresponding to the closest evaluation value). An indicator of “closeness” may be any indicator as long as it represents the distance between vectors or the like (for example, L2 norm or the like).

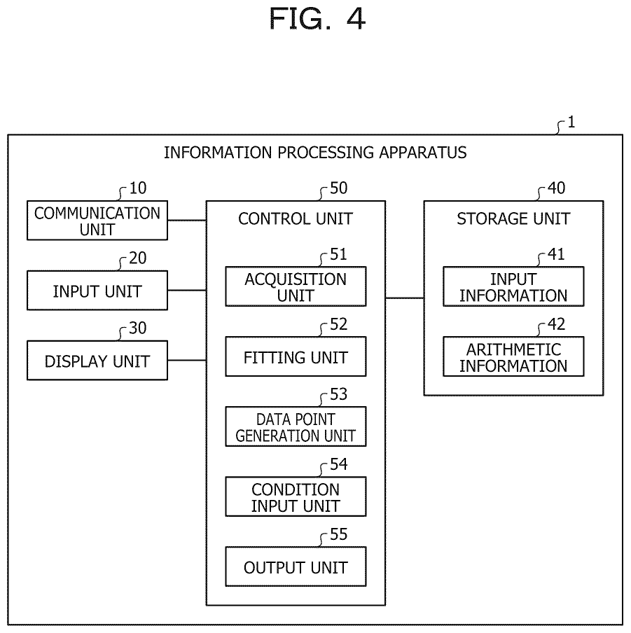

FIG. 4 is a block diagram illustrating an example of the functional configuration of the information processing apparatus according to the embodiment. As illustrated in FIG. 4, an information processing apparatus 1 includes a communication unit 10, an input unit 20, a display unit 30, a storage unit 40, and a control unit 50. For example, a personal computer (PC) or the like may be applied as the information processing apparatus 1.

The communication unit 10 receives various types of data from an external device via a network. The communication unit 10 is an example of a communication device. For example, the communication unit 10 may receive a part or all of input information 41 to be described later from the external device.

The input unit 20 is an input device that inputs various types of information to the control unit 50 of the information processing apparatus 1. The input unit 20 corresponds to a keyboard, a mouse, a touch panel, or the like. For example, the input unit 20 receives a part or all of the input information 41 to be described later by an input operation from a user.

The display unit 30 is a display device that displays information output from the control unit 50. For example, the display unit 30 displays a processing result or the like in the information processing apparatus 1.

The storage unit 40 stores the input information 41 and arithmetic information 42. The storage unit 40 corresponds to a semiconductor memory element such as a random-access memory (RAM) or a flash memory, or a storage device such as a hard disk drive (HDD).

The input information 41 is information related to input to the information processing apparatus 1. For example, the input information 41 includes a plurality of solutions over a Pareto front (Pareto solution set), which is a calculation result of a multi-objective optimization problem, and evaluation values corresponding to the Pareto solution set (Pareto front).

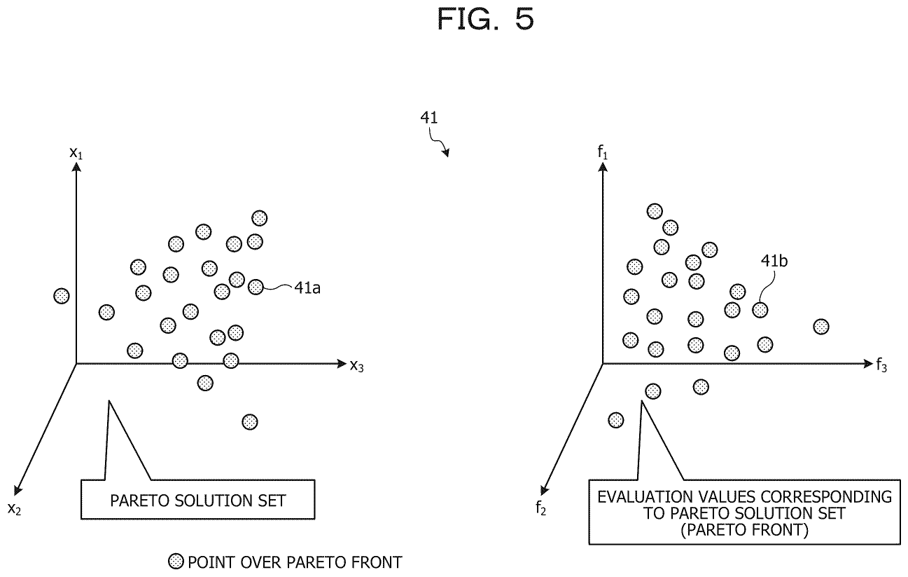

FIG. 5 is an explanatory diagram for describing an example of the input information 41. As illustrated in FIG. 5, the input information 41 includes a plurality of solutions 41a (Pareto solution set) related to x₁, x₂, and x₃. For example, in the case of selection of a design value in designing an airplane, xi, x₂, and x₃ correspond to (blade thickness), (blade length), and the like.

The input information 41 includes evaluation values 41b related to f₁, f₂, and f₃ corresponding to the Pareto solution set (Pareto front). For example, in the case of selection of a design value in designing an airplane, f₁, f₂, and f₃ correspond to (−1 times of lift), (air resistance), and the like that serve as evaluation indicators.

The arithmetic information 42 is various types of data obtained by arithmetic processing of the information processing apparatus 1. For example, the arithmetic information 42 includes a result obtained by the processing of a fitting unit 52, a data point generation unit 53, and the like based on the input information 41. For example, the arithmetic information 42 includes a Bezier simplex, a plurality of data points over the Bezier simplex, and the like (details will be described later).

The control unit 50 includes an acquisition unit 51, the fitting unit 52, the data point generation unit 53, a condition input unit 54, and an output unit 55. The control unit 50 is implemented by a central processing unit (CPU), a graphics processing unit (GPU), a hard wired logic such as an application-specific integrated circuit (ASIC) or a field-programmable gate array (FPGA), and the like.

The acquisition unit 51 is a processing unit that acquires first graph data related to the solutions 41a over a Pareto front input via the communication unit 10 or the input unit 20 and second graph data related to the evaluation values 41b corresponding to the solutions 41a.

For example, the acquisition unit 51 acquires the plurality of solutions 41a over a Pareto front (Pareto solution set) described above and the evaluation values 41b corresponding to the Pareto solution set (Pareto front) via the communication unit 10 or the input unit 20. For example, the plurality of solutions 41a over a Pareto front (Pareto solution set) and the evaluation values 41b corresponding to the Pareto solution set (Pareto front) are obtained by applying a multi-objective optimization algorithm such as a genetic algorithm. The acquisition unit 51 stores the acquired data in the storage unit 40 as the input information 41.

The fitting unit 52 is a processing unit that fits a Bezier simplex to the plurality of solutions 41a over a Pareto front, for example, the first graph data and the evaluation values 41b respectively corresponding to the solutions 41a, for example, the second graph data, which have been acquired by the acquisition unit 51.

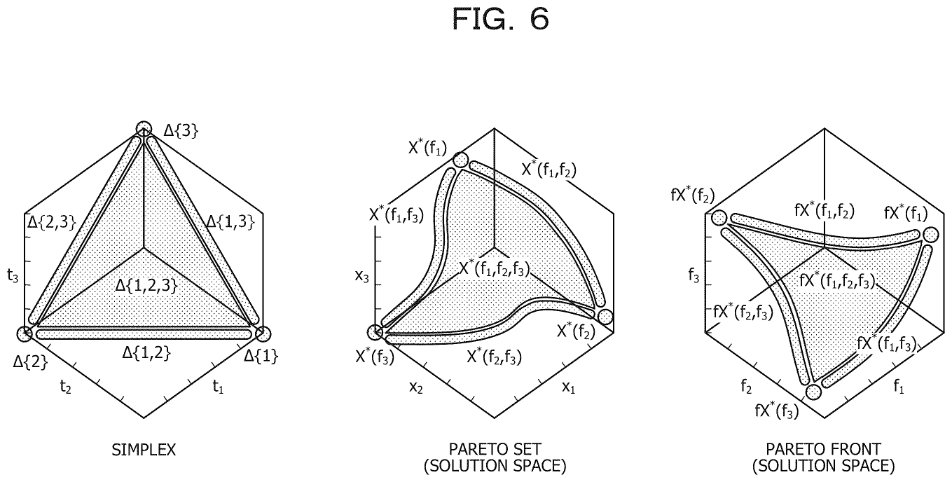

Pareto front appearing in reality is often simplicial. FIG. 6 is an explanatory diagram for describing that a Pareto front is simplicial.

As illustrated in FIG. 6, a Pareto front may be represented by a simplex of a curved “(number of objective functions) 1”-dimensional triangle. In this case, some of the solutions of a problem of optimizing objective functions correspond to the vertices, edges, surface, . . . of a triangle. It is known that such a simplicial multi-objective optimization problem frequently occurs in various fields such as design of an airplane or a diesel engine, a facility arrangement problem, a pure exchange economy, and a water circulation model.

Therefore, by using a Bezier simplex, the fitting unit 52 may perform fitting to the plurality of solutions 41a over a Pareto front and the evaluation values 41b, taking into account the boundary of the solutions corresponding to the above vertices, edges, surface, . . . of a triangle. For example, the fitting unit 52 performs fitting by using an (M−1)-dimensional Bezier simplex of degree D defined by the following formula (1).

$$b ( t ) := {\sum }_{d ∈ {ℕ}_{D}^{N}} ( \begin{matrix}D \\ d\end{matrix} ) {t}^{d} {p}_{d} ( t ∈ {Δ}^{M - 1} ) \qquad ( 1 )$$

In formula (1), b(t) corresponds to a Bezier simplex (mapping). t is a parameter of an M-dimensional real vector. (D d) is a multinomial coefficient. t^{d} is a monomial (multiple index) of degree D. p_{d} is a control point of the M-dimensional real vector. Δ^{m-1} represents an (M−1)-dimensional simplex. The number of control points of a Bezier simplex is determined by the degree D and the dimension M.

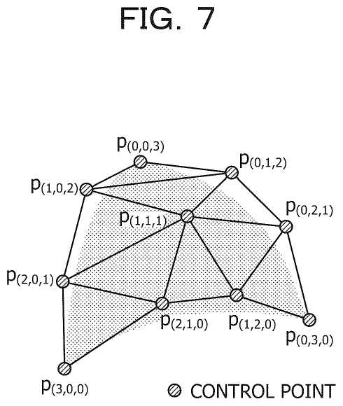

FIG. 7 is an explanatory diagram for describing an example of a Bezier simplex. As illustrated in FIG. 7, a Bezier simplex of a shaded portion is defined by a plurality of control points (p). The number of control points (p) of this Bezier simplex is determined by the degree (D) and the dimension (M).

The illustrated example illustrates a Bezier simplex in which D=3 and M=3. Indices of each control point p(i, j, k) (a circle in FIG. 7) are each an integer of 0 or more, and satisfy i+j+k=D=3. For example, p(3, 0, 0), p(0, 3, 0), and p(0, 0, 3) are control points corresponding to the vertices of a triangle indicating a Bezier simplex, respectively. In the fitting of a Bezier simplex in the illustrated example, estimation is performed such that the control points respectively match the first, second, and third fitting targets (first and second graph data).

For example, the fitting unit 52 estimates the coordinates (vector values) indicating each control point by an inductive skeleton estimation method. The inductive skeleton estimation method is a method of estimation in order from a control point that defines a low-dimensional simplex (skeleton), and the number of control points to be adjusted at one time does not depend on the number of dimensions of fitting targets (first and second graph data). For this reason, in the inductive skeleton estimation method, the number of control points to be adjusted at one time may be reduced even in approximation of a high-dimensional simplex.

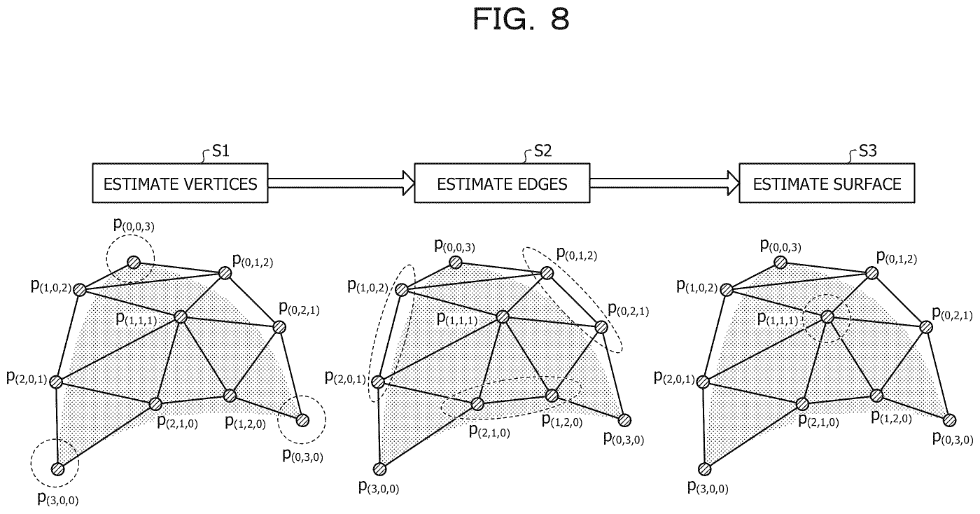

FIG. 8 is an explanatory diagram for describing fitting of a Bezier simplex to a Pareto front. As illustrated in FIG. 8, the fitting unit 52 first estimates the vertices (S1). For example, the fitting unit 52 performs estimation such that p(3, 0, 0) matches the first fitting target (for example, x₁, f₁, or the like), p(0, 3, 0) matches the second fitting target (for example, x₂, f₂, or the like), and p(0, 0, 3) matches the third fitting target (for example, x₃, f₃, or the like).

Next, the fitting unit 52 estimates the edges (S2). For example, the fitting unit 52 estimates the control points that define the shape of the edges of a triangle (dotted line portions of S2) in a state in which the control points p(3, 0, 0), p(0, 3, 0), and p(0, 0, 3) indicating the vertices of the triangle are fixed.

Next, the fitting unit 52 estimates the surface (S3). For example, the fitting unit 52 estimates the control point that defines the shape of the surface of the triangle (dotted line portion of S3) in a state in which the control points corresponding to the vertices and edges of the triangle are fixed.

By the inductive skeleton estimation method described above, the fitting unit 52 applies Bezier simplex fitting to a Pareto solution set (first graph data) and evaluation values corresponding to the Pareto solution set (second graph data).

For example, when

{xₙ}ₙ^{N}=1
is a set of Pareto solutions obtained by multi-objective optimization, the fitting unit 52 performs fitting to
{(xₙ,f(xₙ))}ₙ₌₁^{N}.

x is

x=[x₁,x₂, . . . , x_{L}]^{T}ϵ [symbol] ^{L}: a vector of input.

f is a function that returns a vector of an evaluation value to f: [symbol] ^{L}→ [symbol] ^{M} input, for example, f(x)=[f₁(x), f₂(x), . . . , f_{M}(x)]^{T}.

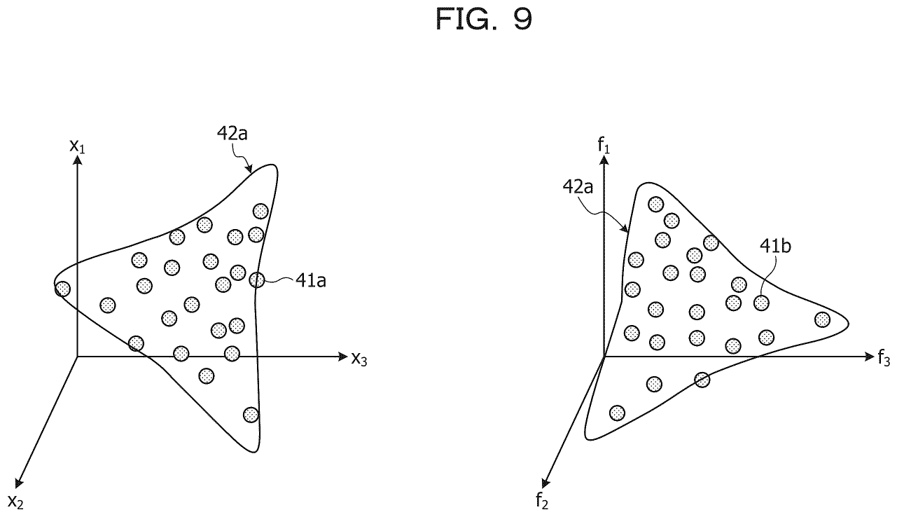

FIG. 9 is an explanatory diagram for describing an example of visualization of a Pareto front by fitting. As illustrated in FIG. 9, the fitting unit 52 fits a Bezier simplex 42a by estimating each control point (p) based on the plurality of solutions 41a over a Pareto front (first graph data). Similarly, the fitting unit 52 fits the Bezier simplex 42a by estimating each control point (p) based on the evaluation values 41b respectively corresponding to the plurality of solutions 41a (second graph data). Next, the fitting unit 52 stores information indicating the Bezier simplex 42a fitted in this manner (coordinate values of a plurality of control points or the like) in the arithmetic information 42.

The data point generation unit 53 is a processing unit that generates a plurality of data points over the Bezier simplex 42a fitted to each of the first graph data and second graph data.

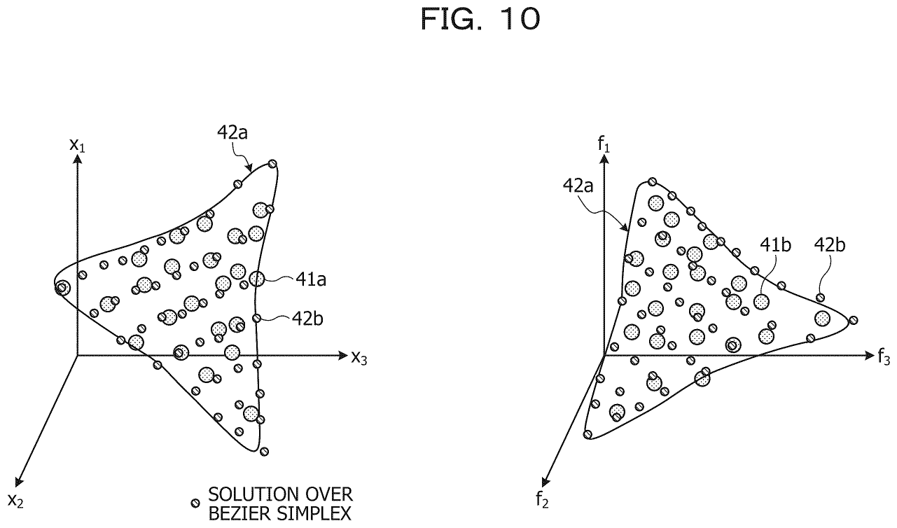

FIG. 10 is an explanatory diagram for describing an example of data points over the Bezier simplex 42a. As illustrated in FIG. 10, the data point generation unit 53 generates a plurality of data points 42b in a grid form over the Bezier simplex 42a defined by the plurality of control points (p). An interval between the data points 42b generated in a grid form may be set in advance by a user. The data point generation unit 53 stores information related to the generated data points 42b (for example, coordinate values) in the arithmetic information 42. The data points 42b over the Bezier simplex 42a fitted to the first graph data (left side in FIG. 10) correspond to a solution set over the Bezier simplex 42a.

The condition input unit 54 is a processing unit that receives input of a condition for evaluation values. For example, the condition input unit 54 receives specification of a section (area) of evaluation values for which solutions are desired to be presented, based on an input operation by a user via the input unit 20 or the like. Such specification of a condition may also be referred to as specification indicating a range of value for each evaluation value.

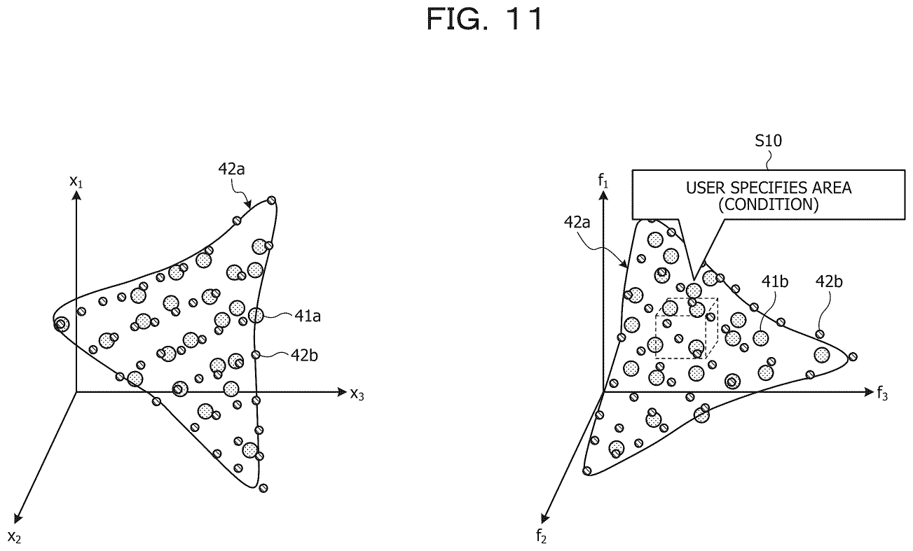

FIG. 11 is an explanatory diagram for describing an example of condition specification by a user. As illustrated in FIG. 11, in a case where there are three evaluation values of f₁, f₂, and f₃, a user specifies an area (condition of upper limit and lower limit) related to each evaluation value (S10).

The output unit 55 is a processing unit that outputs solutions corresponding to a condition received by the condition input unit 54. For example, the output unit 55 refers to the information related to the data points 42b (for example, coordinate values) stored in the arithmetic information 42, and selects data points included in an area corresponding to a condition received by the condition input unit 54 from the data points 42b over the Bezier simplex 42a fitted to the second graph data. In a case where there is no data point 42b included in the condition (area) received by the condition input unit 54, the output unit 55 calculates the distance between vectors such as L2 norm and selects the data point 42b closest to the area. Next, the output unit 55 outputs solutions indicated by the data points 42b over the Bezier simplex 42a fitted to the first graph data, corresponding to the selected data points.

For example, the output unit 55 generates a visualized image in which the Bezier simplex 42a and the data points 42b in the arithmetic information 42 are plotted in a two-dimensional space or a three-dimensional space corresponding to two dimensional or three dimensional solutions and evaluation values. Next, the output unit 55 causes the solutions indicated by the data points 42b corresponding to the condition (area) received by the condition input unit 54 to be displayed in a display mode different from that of the other data points 42b. Accordingly, the information processing apparatus 1 may present solutions to a user in a more understandable manner.

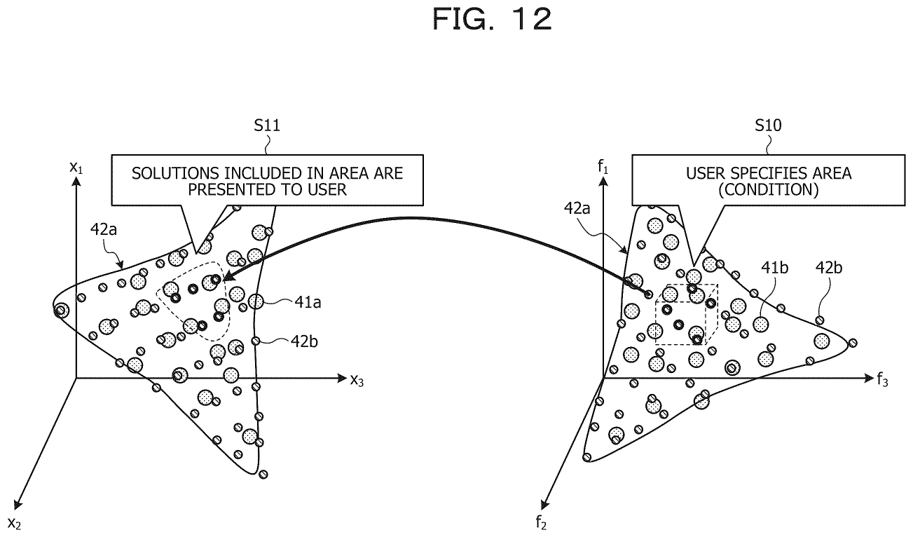

FIG. 12 is an explanatory diagram for describing an example of presentation of solutions in response to condition specification. As illustrated in FIG. 12, the output unit 55 surrounds the data points 42b (solutions) corresponding to a condition (area) received by the condition input unit 54 with a dotted area frame, or displays the data points 42b themselves in a display mode (thickness or darkness) different from that of the other data points. Accordingly, a user may easily identify solutions corresponding to condition specification.

For example, in a case where the number of evaluation indicators (f₁, f₂, and f₃ . . . ) and the number of design variables (x₁, x₂, and x₃ . . . ) are four or more, an image may not be displayed as a two-dimensional or three-dimensional visualized image.

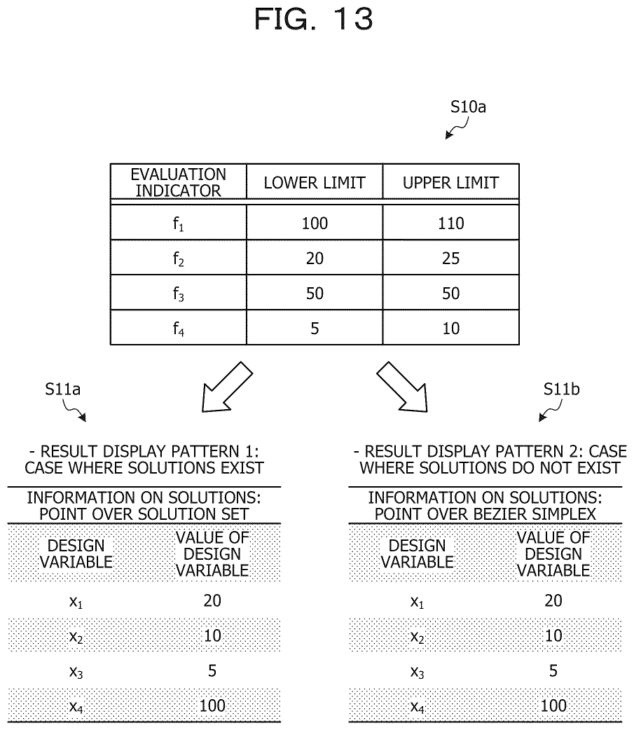

FIG. 13 is an explanatory diagram for describing an example of condition specification by a user and presentation of solutions. As illustrated in FIG. 13, the number of evaluation indicators is four (f₁, f₂, f₃, and f₄), and the number of design variables is also four (x₁, x₂, x₃, and x₄).

In such a case, a user sets a condition of upper limit and lower limit for each of the four evaluation indicators. The output unit 55 outputs the values of design variables (x₁, x₂, and x₃ . . . ) corresponding to the evaluation indicators satisfying the condition specified by the user.

Result display patterns in the output unit 55 includes a case where the data points 42b (solutions) included in a condition (area) received by the condition input unit 54 exist (S11a) and a case where such data points do not exist (S11b). In the case where the solutions exist (S11a), the output unit 55 outputs the corresponding information on the solutions (values of design variables). In the case where the solutions do not exist (S11b), the output unit 55 outputs information (value of design variable) on the data point 42b over the Bezier simplex 42a closest to the area.

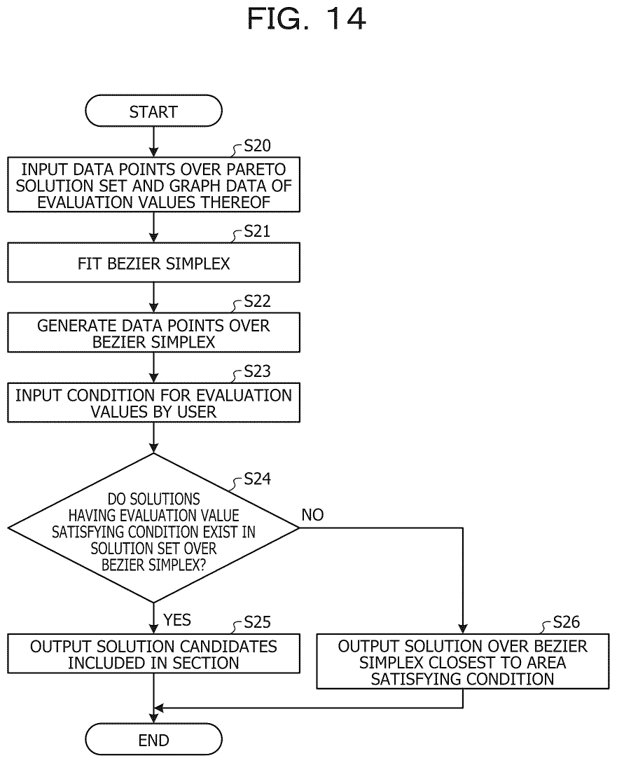

FIG. 14 is a flowchart illustrating an example of the operation of the information processing apparatus according to the embodiment. As illustrated in FIG. 14, when processing is started, the acquisition unit 51 receives input of data points over a Pareto solution set (first graph data) and graph data of evaluation values corresponding to the Pareto solution set (S20).

Next, the fitting unit 52 fits the Bezier simplex 42a to the graph data acquired by the acquisition unit 51 (S21). Next, the data point generation unit 53 generates the plurality of data points 42b in a grid form over the Bezier simplex 42a (S22).

Next, the condition input unit 54 receives a condition for evaluation values input by a user via the communication unit 10 (S23). Next, the output unit 55 refers to the information related to the data points 42b (for example, coordinate values) stored in the arithmetic information 42, and determines whether solutions having an evaluation value satisfying the received condition exist in the solution set over the Bezier simplex 42a (S24).

When the solutions satisfying the received condition exist (S24: Yes), the output unit 55 outputs the solution candidates included in the section (condition) (S25), and ends the processing. When the solutions satisfying the received condition do not exist (S24: No), the output unit 55 calculates the distance between vectors such as L2 norm, outputs the solution over the Bezier simplex 42a closest to the area satisfying the condition (S26), and ends the processing.

As described above, the information processing apparatus 1 acquires first graph data related to the solutions 41a over a Pareto front and second graph data related to the evaluation values 41b corresponding to the solutions. The information processing apparatus 1 fits the Bezier simplex 42a to each of the acquired first graph data and second graph data. The information processing apparatus 1 generates a plurality of data points over the Bezier simplex 42a fitted to each of the first graph data and second graph data. The information processing apparatus 1 receives input of a condition for evaluation values. The information processing apparatus 1 outputs solutions indicated by data points over a Bezier simplex fitted to the first graph data, the solutions corresponding to data points over a Bezier simplex fitted to the second graph data selected based on the received condition.

Accordingly, by inputting a condition for evaluation values, a user may easily know the solutions satisfying the condition for evaluation values. For example, in the information processing apparatus 1, it is easy to select a solution desired by a user. As described above, the information processing apparatus 1 may support selection of a solution by a user.

The information processing apparatus 1 selects data points in an area corresponding to a condition from the data points over the Bezier simplex 42a fitted to the second graph data. Accordingly, the information processing apparatus 1 may present solutions indicated by data points over the Bezier simplex 42a fitted to the first graph data, the solutions corresponding to the data points (evaluation values) matching the condition. For this reason, a user may easily find solutions corresponding to the evaluation values matching the input condition.

In a case where there is no data point in the area corresponding to the condition in the data points over the Bezier simplex fitted to the second graph data, the information processing apparatus 1 selects a data point closest to this area. Accordingly, the information processing apparatus 1 may present a solution corresponding to a data point (evaluation value) closer to the condition. For this reason, a user may easily find a solution corresponding to an evaluation value close to the input condition.

Each constituent element of the apparatus illustrated in the drawings does not have to be physically configured as illustrated in the drawings. For example, the specific form of the distribution and integration of the apparatus is not limited to the illustrated form, and all or a part of the apparatus may be configured in arbitrary units in a functionally or physically distributed or integrated manner depending on various kinds of loads, usage statuses, and the like. As described above, the support for finding solutions by the information processing apparatus 1 is effective particularly in the case where the number of objective functions is three or more. However, the support for finding solutions by the information processing apparatus 1 may also be applied in a case where the number of objective functions is two or less.

All or some (arbitrary) of the various processing functions of the acquisition unit 51, the fitting unit 52, the data point generation unit 53, the condition input unit 54, and the output unit 55, to be executed in the control unit 50 of the information processing apparatus 1, may be executed in a CPU (or a microcomputer, such as a microprocessor unit (MPU) or a microcontroller unit (MCU)). It goes without saying that all or some (arbitrary) of the various processing functions may be executed in a program analyzed and executed by a CPU (or a microcomputer, such as an MPU or MCU) or in hardware by wired logic. The various processing functions executed in the information processing apparatus 1 may be executed by cloud computing in which a plurality of computers collaborates with each other.

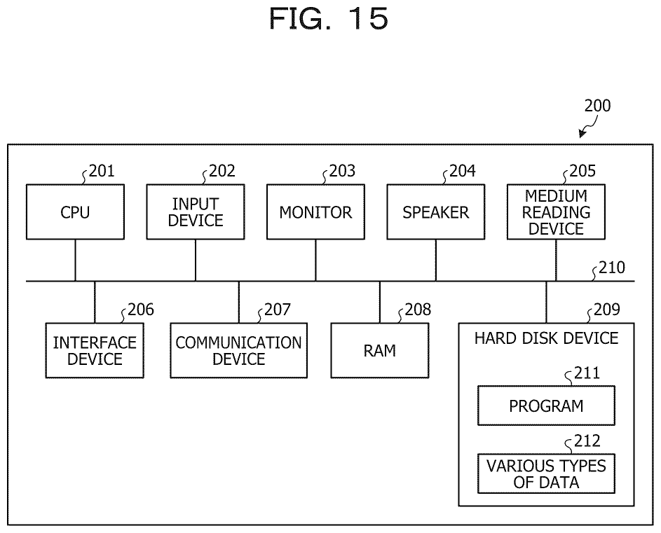

The various types of processing described in the above embodiment may be implemented by a computer executing a program prepared in advance. Hereinafter, an example of the (hardware) configuration of a computer that executes a program having the functions similar to those of the above embodiment will be described. FIG. 15 is an explanatory diagram for describing an example of the configuration of a computer.

As illustrated in FIG. 15, a computer 200 includes a CPU 201 that executes various types of arithmetic processing, an input device 202 that receives data input, a monitor 203, and a speaker 204. The computer 200 includes a medium reading device 205 that reads a program or the like from a storage medium, an interface device 206 for coupling to various devices, and a communication device 207 for communication with and coupling to an external device in a wired or wireless manner. The computer 200 includes a RAM 208 that temporarily stores various types of information, and a hard disk device 209. The components (201 to 209) in the computer 200 are coupled to a bus 210.

A program 211 for executing various types of processing in the functional configuration described in the above embodiment (for example, the acquisition unit 51, the fitting unit 52, the data point generation unit 53, the condition input unit 54, and the output unit 55) is stored in the hard disk device 209. The hard disk device 209 stores various types of data 212 to be referred to by the program 211. For example, the input device 202 receives input of operation information from an operator. For example, the monitor 203 displays various screens to be operated by an operator. For example, a printer or the like is coupled to the interface device 206. The communication device 207 is coupled to a communication network such as a local area network (LAN), and exchanges various types of information with an external device via the communication network.

The CPU 201 performs various types of processing related to the above functional configuration (for example, the acquisition unit 51, the fitting unit 52, the data point generation unit 53, the condition input unit 54, and the output unit 55) by reading the program 211 stored in the hard disk device 209, loading the program to the RAM 208, and executing the program. The program 211 does not have to be stored in the hard disk device 209. For example, the program 211 stored in a storage medium readable by the computer 200 may be read and executed. For example, the storage medium readable by the computer 200 corresponds to a portable-type recording medium such as a compact disc read-only memory (CD-ROM), a Digital Versatile Disc (DVD), or a Universal Serial Bus (USB) memory, a semiconductor memory such as a flash memory, a hard disk drive, or the like. The program 211 may be stored in a device coupled to a public network, the Internet, a LAN, or the like, and the computer 200 may read and execute the program 211 from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an output program for causing a computer to execute a process, the process comprising:
acquiring first graph data related to solutions over a Pareto front and second graph data related to a plurality of evaluation values corresponding to the solutions;
fitting a Bezier simplex to each of the acquired first graph data and the acquired second graph data;
generating a plurality of data points that corresponds to each other over a Bezier simplex fitted to each of the first graph data and the second graph data;
receiving input of a condition that indicates a range of each of the plurality of evaluation values; and
outputting solutions indicated by data points over a Bezier simplex fitted to the first graph data, the data points corresponding to data points over a Bezier simplex fitted to the second graph data selected based on the received condition.

2. The non-transitory computer-readable recording medium according to claim 1, wherein, in the outputting of the solutions, data points in an area corresponding to the condition are selected from data points over a Bezier simplex fitted to the second graph data.

3. The non-transitory computer-readable recording medium according to claim 2, wherein, in the outputting of the solutions, a data point closest to the area is selected in a case where there is no data point in the area in data points over a Bezier simplex fitted to the second graph data.

4. An output method for causing a computer to execute a process, the process comprising:
acquiring first graph data related to solutions over a Pareto front and second graph data related to a plurality of evaluation values corresponding to the solutions;
fitting a Bezier simplex to each of the acquired first graph data and the acquired second graph data;
generating a plurality of data points that corresponds to each other over a Bezier simplex fitted to each of the first graph data and the second graph data;
receiving input of a condition that indicates a range of each of the plurality of evaluation values; and
outputting solutions indicated by data points over a Bezier simplex fitted to the first graph data, the data points corresponding to data points over a Bezier simplex fitted to the second graph data selected based on the received condition.

5. The output method according to claim 4, wherein, in the outputting of the solutions, data points in an area corresponding to the condition are selected from data points over a Bezier simplex fitted to the second graph data.

6. The output method according to claim 5, wherein, in the outputting of the solutions, a data point closest to the area is selected in a case where there is no data point in the area in data points over a Bezier simplex fitted to the second graph data.

7. An information processing apparatus comprising:
a memory; and
a processor coupled to the memory and configured to:
acquire first graph data related to solutions over a Pareto front and second graph data related to a plurality of evaluation values corresponding to the solutions;
fit a Bezier simplex to each of the acquired first graph data and the acquired second graph data;
generate a plurality of data points that corresponds to each other over a Bezier simplex fitted to each of the first graph data and the second graph data;
receive input of a condition that indicates a range of each of the plurality of evaluation values; and
output solutions indicated by data points over a Bezier simplex fitted to the first graph data, the data points corresponding to data points over a Bezier simplex fitted to the second graph data selected based on the received condition.

8. The information processing apparatus according to claim 7, wherein, in the outputting of the solutions, data points in an area corresponding to the condition are selected from data points over a Bezier simplex fitted to the second graph data.

9. The information processing apparatus according to claim 8, wherein, in the outputting of the solutions, a data point closest to the area is selected in a case where there is no data point in the area in data points over a Bezier simplex fitted to the second graph data.
